(19) United States
(12) Patent Application Publication
(10) Pub. No.: US 2008/0108337 A1
(43) Pub. Date: May 8, 2008

(54) Method for advertising on mobile devices

(75) Inventors: Itzhak Pomerantz, Kefar Saba (IL); Eitan Mardiks, Ra'Anana (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD.

(21) Appl. No.: 11/806,700

(22) Filed: Jun. 4, 2007

Related U.S. Application Data
(60) Provisional application No. 60/864,423, filed on Nov. 6, 2006.

(51) Int. Cl. H04Q 7/22

(52) U.S. Cl. 455/414.3

(57) ABSTRACT

A method for mediating messages between an advertiser and a user of a mobile device, the method including the steps of: providing the mobile device with: a local storage memory having a locally-stored database, residing in the mobile device, with at least one advertising message of the advertiser; an ADM, residing in the mobile device, for selecting advertising messages from the database; and an event detector, residing in the mobile device, for detecting at least one event of the mobile device; detecting an occurrence of at least one event using the event detector; locally selecting at least one context-dependent advertising message stored in the database using the ADM, at least one context-dependent advertising message correlated with at least one event; presenting at least one context-dependent advertising message to the user on the mobile device; and remunerating the user for consent to receive at least one context-dependent advertising message.

### RELATED APPLICATIONS

This patent application claims priority under 35 U.S.C. §119(e) to U.S. Provisional Application No. 60/864,423, filed Nov. 6, 2006, which is hereby incorporated by reference in its entirety.

This patent application is related to U.S. patent application Ser. No. ______ of the same inventors, which is entitled “SYSTEM FOR ADVERTISING ON MOBILE DEVICES” and filed on the same day as the present application. This patent application, also claiming priority to U.S. Provisional Application No. 60/864,423, is incorporated in its entirety as if fully set forth herein.

### FIELD AND BACKGROUND OF THE INVENTION

The present invention relates to methods for presenting timely advertising based on user-specific parameters and events, particularly in a mobile-device network. The advertising system is context-dependent, and remunerates a user for allowing presentation of such advertising without requiring user involvement.

Mobile phones have become commodity items that are carried and used by many people. Having a display and a loudspeaker, and being close to the user at all times, a mobile phone serves as an effective tool for providing the user with useful information beyond its basic telephony functionality.

Advertising is one type of information that is delivered to users via mobile phones. There are sophisticated methods in the prior art for delivering advertising content. Since the value of advertising to the advertiser is primarily dependent upon the attention paid by the user to such advertising, the prior art includes means for encouraging the user to pay attention to the advertising, and for verifying that the user has indeed paid sufficient attention to the advertising.

An example of such “feedback-based” mobile-phone advertising is taught by Daniel et al., U.S. Pat. No. 7,039,423, which describes a system that broadcasts an advertisement to a plurality of mobile phones, and remunerates a user that responds to that advertising (by pressing a key) by giving him access to some valuable piece of video content as a compensatory reward.

All prior-art mobile-phone advertising is based on real-time transmission of content over a cellular network, and suffers from at least the following drawbacks:
(1) the expense of repeated transmission of the same content via the cellular bandwidth;
(2) a lack of relevance between the advertising and the specific interest of the user at the moment of presentation;
(3) a built-in latency, due to communication time, between the decision to advertise and the appearance of the content on a user's display device (a latency that may render the content irrelevant to the user);
(4) an inconvenience to the user by requiring the user to respond to the advertising, and manually delete the advertising (e.g. an advertisement in the form of an SMS or MMS message); and
(5) a limited range of remunerations for users that participate in the scheme of the advertising system.

It would be desirable for advertisers, and convenient for users, to have methods that present timely advertising based on user-specific parameters (e.g. location, user profile, and preferences) and events (e.g. an incoming phone call, a wake-up alarm, and a meeting reminder), particularly in a mobile-device network. It would be further desirable if such methods could be context-dependent, and could remunerate a user for allowing presentation of such advertising without requiring user involvement.

### SUMMARY OF THE INVENTION

It is the purpose of the present invention to provide methods for presenting timely advertising based on user-specific parameters and events, particularly in a mobile-device network. The advertising system is context-dependent, and remunerates a user for allowing presentation of such advertising without requiring user involvement.

For the purpose of clarity, several terms which follow are specifically defined for use herein. The term “AdBank” is used herein to refer to a file or a database stored locally in a mobile device that contains advertising data objects (or advertisement objects). Furthermore, an AdBank can be updated remotely by a remote server. The term “event” is used herein to refer to an occurrence in a mobile device, or in the environment of a mobile device, that can be detected by sensors and/or by a program of the device. Examples of such events are: a motion of the device, an occurrence of a program event (e.g. wake-up alarm, meeting reminder), an incoming phone call, a change in the device's roaming environment, and an occurrence of a received coded message.

The terms “advertising-display manager” and “ADM” are used herein to refer to an advertising selection-and-management module that selects, from a collection of advertisement objects (or messages), an object for display on a mobile device, in correlation with one or more of:
(1) the state of the device (e.g. in use or in standby);
(2) previous presentations (i.e. when was the last time the advertisement object was presented);
(3) the identity of an event (e.g. phone ringing, call dialed, and phonebook accessed); and
(4) the environmental parameters (e.g. temperature, time of day, and geographical location).

Examples of how an ADM would make such a selection would be to present an advertisement for a local pizza restaurant when a user dials a number after a specified time in the evening, or to present an advertisement for a flower shop when a call is received from a phone number listed as “home” in the device phonebook. The collection of advertisements for selection can be stored in an AdBank.

The term “event detector” is used herein to refer to a module in a mobile device that detects an event, and triggers an ADM module accordingly. An event detector can be implemented as a software/firmware module, a hardware module, or a combination of both software/firmware and hardware. The terms “mobile network operator” and “MNO” are used herein to refer to an entity that serves a community of mobile-device subscribers.

The terms “identity module” and “IM” are used herein to refer to a secure device that is provided by an MNO to an MNO's subscriber, and is installed in a mobile device. An IM allows an MNO to recognize a user, and to enable operation of the user's device. The terms “subscriber identity module” and “SIM” are used herein to refer to an IM typically used by an MNO that operates according the GSM (Global System for Mobile telecommunication) standard in mobile devices. The term “high-capacity SIM card” is used herein to refer to a SIM card comprising more than 2 megabytes of non-volatile storage. The terms “advertisement object”, “advertisement”, and “ad” are used herein to refer to an advertising message, briefly displayed on a part of the user display of a mobile device, including at least one of text, graphics, links, animation, and sound in the message.

The term “user context” is used herein to refer to information that is available to the mobile device about the current state of the user. Examples of user context include:
(1) the physical location of the user, based on means known in the art of location detection techniques embedded in the mobile device;
(2) the “motion state” of the user (e.g. rests, walks, and drives), based on accelerometer means embedded in the mobile device;
(3) the temperature of the air, based on measurements from a thermometer embedded in the mobile device;
(4) the “climatic state” of the user, based on weather reports and the “environmental location” of the user (e.g. indoors or outdoors); and
(5) the “physical state” of the user, determined by a “perspiration factor” based on a galvanic skin-response (GSR) of the user, which is sensed by electrodes on the mobile device.

The term “remuneration” is used herein to refer to a relationship between an MNO and a subscriber, by which the subscriber gives consent to be presented with advertising messages, and the MNO compensates the subscriber with valuable services for providing such consent. The term “context-dependent advertising” is used herein to refer to advertising whose content and timing are decided by an ADM according to the state and user context of a mobile device. An example of context-dependent advertising is to advertise a restaurant (e.g. “John's Pizza”) when a different restaurant (e.g. “Bill's Pizza”) is being dialed. The terms “open-loop advertisement” and “OLA” are used herein to refer to a property of an advertising application, running on a mobile device that does not expect or require any user response for billing the advertiser or remunerating the user.

The present invention teaches methods for providing a mobile-device user with relevant advertising, with relatively low consumption of network bandwidth, and with tangible remuneration for allowing the advertising to be displayed on the user's device.

An essential feature of the present invention is the autonomous selection and timing of the advertising. The present invention teaches an OLA system in a mobile device where the advertisement selection and timing is made locally (i.e. by the device's system). Such a system takes advantage of a mass-storage device (e.g. high-capacity SIM card) that belongs to the MNO, resides in the mobile device of the user, contains a large library of advertisement objects, and utilizes an automated “ad manager” (i.e. ADM) to select and display context-dependent advertising messages on the display of the user's device from the library. The present invention also teaches a system that monitors the amount of “display time” consumed by the advertisements, and maintains a “user account” that is used for remunerating the user and billing the advertisers.

The embodiments of the present invention described above that involve a mobile-device implementation are special cases of a broader aspect of the present invention, and are brought as practical examples of how the broader invention can be implemented.

Some of the essential features of the present invention, in its broader context, are the “linkages” among the three following elements:
(1) a detectable user context in the real-world environment (i.e. the entire “context” of the user);
(2) remuneration of a user; and
(3) billing of an advertiser.

The present invention teaches that such linkages are made when a event in the real-world environment is detected (by an event-detecting device), and as a result, a process on a device is launched, thereby causing three actions:
(1) displaying an OLA from a local AdBank on the device;
(2) remunerating credit to the user of the device; and
(3) billing the advertiser of the OLA.

This process is not dependent upon any reaction of, response by, or interaction with the user. The user, according to the present invention, is remunerated for consent to have such a system operating on the user's device. The advertiser is billed for the display time of the advertisements on the device. The motivation of the advertiser to pay for the service is derived from the belief that the user context will naturally cause the user to pay attention to the display due to the correlation between the content of the advertising and the user context.

The following examples are application scenarios of the present invention:

TABLE 1
Exemplary application scenarios of the present invention.

| Advertiser | Device | Event | Advertisement |
|---|---|---|---|
| The Royal | mobile | Phone rings; nearest base | When in London, |
| Theatre in | phone | station is aboard the ferry | see the show |
| London | | from Paris to London | “The Producers” |
| Flower shop | mobile | Phone rings from “Home” | An offer to have |
| | phone | phonebook entry | flowers delivered to |
| | | | the “Home”address |
| Pizza | mobile | A number is dialed around | Location of a nearby |
| restaurant | phone | midnight | pizza restaurant |
| | | | provided |

In a preferred embodiment of the present invention, the advertising messages are stored in the mass-storage area of a high-capacity SIM card.

In a preferred embodiment of the present invention, the stored advertising content is updated in the background by the MNO.

In preferred embodiments of the present invention, the ADM uses the phone number dialed by the user, the local base-station identity, the incoming-call phone number, the time and date, a motion indication (obtained from an accelerometer on board the device), and/or a phonebook, Yellow Pages, or any other resident database information that is associated with the dialed numbers as a context for selecting a message to be displayed.

In other preferred embodiments of the present invention, the remuneration includes discounted or free air-time to the user, access to stored entertainment content on the SIM card, privileges to use applications stored in the SIM card, privileged access to features in applications stored in the SIM card, and/or privileged access to storage areas in the SIM card.

It should be emphasized that one of the ways the system of the present invention differs from the prior art is by providing an advertising experience in which the advertising decision is being made locally in the device. This is achieved by combining two features that make the advertising effective and acceptable: (1) the content of the advertising is highly context-dependent; and (2) the timing of the advertising is closely linked with the context. These features are made possible by having the advertising bank stored locally in the device.

Therefore, according to the present invention, there is provided for the first time a method for selecting and presenting advertising to a user of a mobile device, the method including the steps of: (a) locally selecting at least one context-dependent advertising message from a locally-stored database residing in the mobile device, the step of selecting being performed in the mobile device; and (b) presenting at least one context-dependent advertising message to the user on the mobile device.

Preferably, the step of selecting is performed by an ADM.

According to the present invention, there is provided for the first time a method for mediating messages between an advertiser and a user of a mobile device, the method including the steps of: (a) providing the mobile device with: (i) a local storage memory having a locally-stored database, residing in the mobile device, with at least one advertising message of the advertiser; (ii) an ADM, residing in the mobile device, for selecting advertising messages from the database; and (iii) an event detector, residing in the mobile device, for detecting at least one event of the mobile device; (b) detecting an occurrence of at least one event using the event detector; (c) locally selecting at least one context-dependent advertising message stored in the database using the ADM, at least one context-dependent advertising message correlated with at least one event; (d) presenting at least one context-dependent advertising message to the user on the mobile device; and (e) remunerating the user for consent to receive at least one context-dependent advertising message.

Preferably, the step of remunerating is based on a number of at least one context-dependent advertising message presented to the user on the mobile device.

Preferably, the step of remunerating is based on an amount of display time that at least one context-dependent advertising message is presented to the user on the mobile device.

Preferably, the step of remunerating is performed by an MNO.

Preferably, at least one event is selected from the group consisting of: an occurrence of a dialed number, an occurrence of a call-waiting number, an occurrence of an incoming-call number, an event containing the dialed number, an event containing the call-waiting number, an event containing the incoming-call number, database information about the dialed number, database information about the call-waiting number, database information about the incoming-call number, a location of the device, a local time on the device, an occurrence of a reminder, an occurrence of an wake-up alarm, an occurrence of a received coded message, an indication of physical contact between the user and the device, and an indication of motion of the device.

Preferably, the local storage memory is a high-capacity SIM card operative to store the locally-stored database.

Preferably, the method further includes the step of: (f) billing the advertiser based on an amount of display time that at least one advertising message, of the advertiser, is presented to the user on the mobile device.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified block diagram of the communication among the advertisers, MNO, and mobile device of an OLA system, according to a preferred embodiment of the present invention;

FIG. 2 shows a simplified block diagram of the components implemented in an OLA system and the communication channels between the components, according to a preferred embodiment of the present invention.

### DESCRIPTION OF THE PREFERRED EMBODIMENTS

The present invention relates to methods for presenting timely advertising based on user-specific parameters and events, particularly in a mobile-device network. The principles and operation for presenting timely advertising based on user-specific parameters and events, according to the present invention, may be better understood with reference to the accompanying description and the drawings.

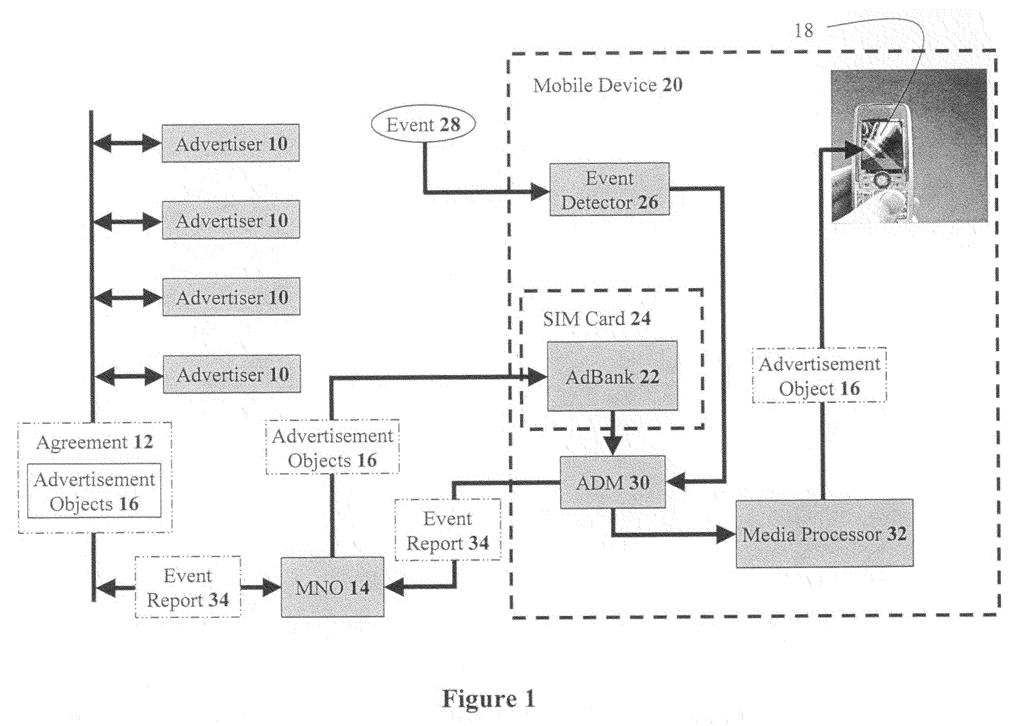

Referring now to the drawings, FIG. 1 is a simplified block diagram of the communication among the advertisers, MNO, and mobile device of an OLA system, according to a preferred embodiment of the present invention. Advertisers 10 sign an agreement 12 with an MNO 14. Agreement 12 includes a set of advertisement objects 16, and the “air-time” charges advertisers 10 will be billed for displaying advertisement objects 16 on a user display 18 of a mobile device 20. Advertisement objects 16 are OLAs, and do not require any response from the user. An AdBank 22, containing advertisement objects 16, is located in a high-capacity SIM card 24 provided to the user of mobile device 20 by MNO 14. Advertisement objects 16 are preloaded by MNO 14 according to agreement 12 with advertisers 10.

An event detector 26, which detects an event 28, delivers event 28 to an ADM 30. ADM 30 then selects one of advertisement objects 16 from AdBank 22 according to context-based selection criteria, and sends the selected advertisement object 16 to a media possessor 32 for presentation on user display 18. The user of mobile device 20 is remunerated according to an event report 34 sent periodically to MNO 14. Event report 34 is also used to bill advertisers 10. It is noted that in alternative embodiments of the present invention event detector 26 and ADM 30 reside in high-capacity SIM card 24.

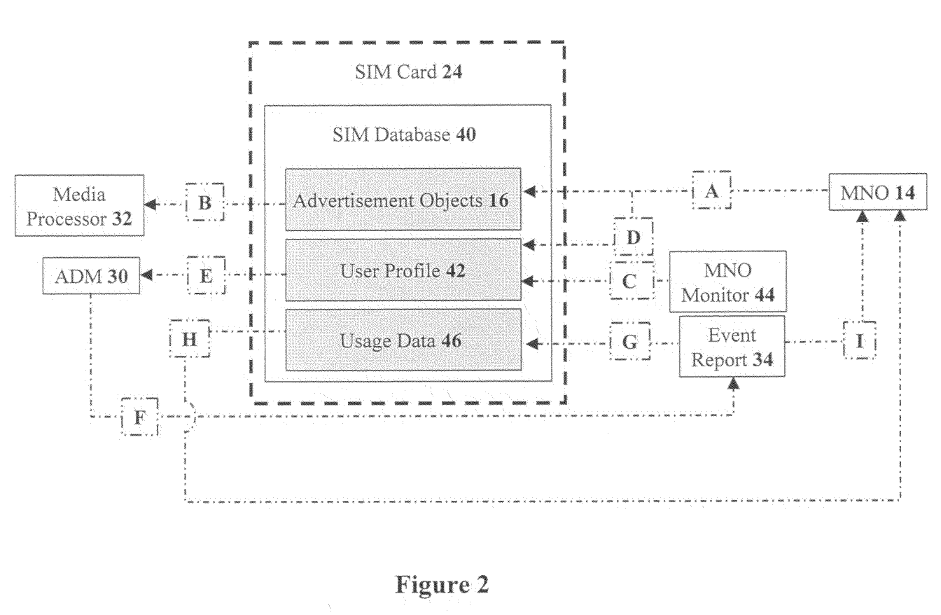

FIG. 2 shows a simplified block diagram of the components implemented in an OLA system and the communication channels between the components, according to a preferred embodiment of the present invention. The components stored in a SIM database 40 of high-capacity SIM card 24, and how they interface with the OLA system, are shown. Advertisement objects 16 are preloaded by MNO 14 before providing SIM card 24 to the user (Channel A), and can be subsequently updated by downloading from MNO 14 to SIM card 24 over the network of MNO 14. As soon as event detector 26 detects event 28, ADM 30 selects an advertisement object 16 from SIM database 40, and sends the selected advertisement object 16 to media processor 32 (Channel B). A user profile 42 includes preferences of the user and information about the next advertisement object 16 to be displayed in a given context.

An example of how user profile 42 is utilized is the decision to promote a context-relevant store when the user is within the network coverage of an MNO base-station located in a shopping mall. For example, if user profile 42 indicates that the user is a child, ADM 30 may send a toy-store ad, while if the user is a female adult, ADM 30 may send a fashion-store ad, and if the user is a male adult, ADM 30 may send a male-clothing ad. User profile 42 is updated by an MNO monitor 44 that collects information on the user's activities (e.g. time of calls, length of calls, and dialed numbers) (Channel C). User profile 42 is also updated by MNO 14 (Channel D), which may have additional means for classifying the user.

User profile 42 is retrieved by ADM 30 (Channel E), and used together with the context to select the next advertisement object 16. ADM 30 also generates event report 34 (Channel F). Usage data 46 is updated by event report 34 (Channel G), and typically resides in SIM card 24. Event report 34 keeps track of the number of retrieved advertisement objects 16 and the duration of time that the advertisement-object application has been activated. Usage data 46 (Channel H), as well as event report 34 (Channel I), are provided to MNO 14. While event report 34 is used by MNO 14 for remunerating the user and billing advertisers 10, usage data 46 is used by MNO 14 to record a total “advertisement consumption” of the user. Such a record of advertisement consumption can be used by MNO 14, for example, to modify user profile 42 (Channel D).

It should be noted that some of the essential features of the present invention are that the OLA system is relevant (i.e. in content and in timeliness) and helpful to the user without being a nuisance. Such features of the present invention are achieved by providing the following aspects:
(1) a local advertisement-management system, enabling instant response to detection of relevant context by retrieving the content from a local storage;
(2) the absence of user involvement (e.g. a challenge-response), enabling non-intrusive, close to subliminal, messaging; and
(3) context- and state-awareness of the device, enabling selection of the messages by their content relevance to the user.

While the invention has been described with respect to a limited number of embodiments, it will be appreciated that many variations, modifications, and other applications of the invention may be made.

What is claimed is:

1. A method for selecting and presenting advertising to a user of a mobile device, the method comprising the steps of:
(a) locally selecting at least one context-dependent advertising message from a locally-stored database residing in the mobile device, said step of selecting being performed in the mobile device; and
(b) presenting said at least one context-dependent advertising message to the user on the mobile device.

2. The method of claim 1, wherein said step of selecting is performed by an ADM.

3. A method for mediating messages between an advertiser and a user of a mobile device, the method comprising the steps of:
(a) providing the mobile device with:
(i) a local storage memory having a locally-stored database, residing in the mobile device, with at least one advertising message of the advertiser;
(ii) an ADM, residing in the mobile device, for selecting advertising messages from said database; and
(iii) an event detector, residing in the mobile device, for detecting at least one event of the mobile device;
(b) detecting an occurrence of said at least one event using said event detector;
(c) locally selecting at least one context-dependent advertising message stored in said database using said ADM, said at least one context-dependent advertising message correlated with said at least one event;
(d) presenting said at least one context-dependent advertising message to the user on the mobile device; and
(e) remunerating the user for consent to receive said at least one context-dependent advertising message.

4. The method of claim 3, wherein said step of remunerating is based on a number of said at least one context-dependent advertising message presented to the user on the mobile device.

5. The method of claim 3, wherein said step of remunerating is based on an amount of display time that said at least one context-dependent advertising message is presented to the user on the mobile device.

6. The method of claim 3, wherein said step of remunerating is performed by an MNO.

7. The method of claim 3, wherein said at least one event is selected from the group consisting of: an occurrence of a dialed number, an occurrence of a call-waiting number, an occurrence of an incoming-call number, an event containing said dialed number, an event containing said call-waiting number, an event containing said incoming-call number, database information about said dialed number, database information about said call-waiting number, database information about said incoming-call number, a location of the device, a local time on the device, an occurrence of a reminder, an occurrence of an wake-up alarm, an occurrence of a received coded message, an indication of physical contact between the user and the device, and an indication of motion of the device.

8. The method of claim 3, wherein said local storage memory is a high-capacity SIM card operative to store said locally-stored database.

9. The method of claim 3, the method further comprising the step of:
(f) billing the advertiser based on an amount of display time that said at least one advertising message, of the advertiser, is presented to the user on the mobile device.
